(19) United States
(12) Patent Application Publication
(10) Pub. No.: US 2017/0213256 A1
(43) Pub. Date: Jul. 27, 2017

(54) PROVIDING ADVERTISEMENTS USING DYNAMIC SLOT-SIZE-COMPATIBLE STYLE DEFINITIONS

(71) Applicant: Google Inc., (US)

(72) Inventor: Yasser Abu Ghdeeb, Dublin (IE)

(73) Assignee: Google Inc., Mountain View, CA (US)

(21) Appl. No.: 13/793,872

(22) Filed: Mar. 11, 2013

(51) Int. Cl. G06Q 30/02

(52) U.S. Cl. CPC G06Q 30/0277

(57) ABSTRACT

Methods, systems, and apparatus include a method for identifying content for inclusion in a display advertisement to be presented in a block having dimensions that may vary depending on a given received request. The method includes receiving style definitions to be associated with the display advertisement, each style definition being different and including a layout for the content to be used as criteria for when to apply a given style definition when generating an instantiation of the display advertisement. The method further includes receiving a request for content including size information for a block where the content is to be displayed, determining that the display advertisement satisfies the request, determining which style definition to apply based on the size information and criteria for each of the plurality of style definitions, generating an instantiation of the display advertisement using the determined style definition, and providing the instantiation of the display advertisement.

### BACKGROUND

This specification relates to information presentation.

The Internet provides access to a wide variety of resources. For example, video and/or audio files, as well as webpages for particular subjects or particular news articles, are accessible over the Internet. Access to these resources presents opportunities for other content (e.g., advertisements) to be provided with the resources. For example, a webpage can include slots in which content can be presented. These slots can be defined in the webpage or defined for presentation with a webpage, for example, along with search results.

Content blocks (including one or more slots) can be allocated to content sponsors as part of a reservation system, or in an auction. For example, content sponsors can provide bids specifying amounts that the sponsors are respectively willing to pay for presentation of their content. In turn, an auction can be run, and the slots can be allocated to sponsors according, among other things, to their bids and/or the relevance of the sponsored content to content presented on a page hosting the slot or a request that is received for the sponsored content. The content can then be provided to the user on any devices associated with the user such as a personal computer (PC), a smartphone, a laptop computer, a tablet computer, or some other user device. Content blocks can be of different sizes depending on the space available on a web page and/or the space defined by a publisher.

### SUMMARY

In general, one innovative aspect of the subject matter described in this specification can be implemented in methods that include a computer-implemented method for identifying content for inclusion in a display advertisement, the display advertisement to be presented in a block that has dimensions that may vary depending on a given received request. The method includes receiving a plurality of style definitions to be associated with the display advertisement, each style definition being different and including a layout for the content to be used as criteria for when to apply a given style definition when generating an instantiation of the display advertisement for presentation to a user. The method further includes receiving a request for content including size information for a block where the content is to be displayed. The method further includes determining that the display advertisement satisfies the request and is to be provided responsive to the request. The method further includes determining, by one or more processors, which style definition to apply based at least in part on the size information and criteria for each of the plurality of style definitions that are associated with the display advertisement. The method further includes generating an instantiation of the display advertisement using the determined style definition. The method further includes providing the instantiation of the display advertisement responsive to the request.

These and other implementations can each optionally include one or more of the following features. The content for inclusion in the display advertisement can include one or more of text, image, video, hypertext markup language, canvas and flash data. Determining can include mapping a respective style definition to a range of values for a height and a width of the block that is supported by the respective style definition. The layout can define the location and size of the content to be included in a given instantiation of the display advertisement when using a respective style definition. The layout can include for at least one element of content a range of sizes that can be included in a given instantiation depending on the size information. The method can further include determining a plurality of eligible content items that are responsive to the request, conducting an auction including the plurality of eligible content items, and where determining the display advertisement satisfies the request and is to be provided responsive to the request includes determining the display advertisement is a winner of the auction. The method can further include providing a user interface for receiving style definition information from a display advertisement sponsor including layout information and criteria information for when to apply a respective style definition. The style definition can be of the form of a cascading style sheet. The size information can be based on a block size selected by a publisher of a page in which the display advertisement is to be presented, and the block size can be arbitrary or customizable by the publisher and not necessarily a standard size specified by an advertisement serving system.

In general, another innovative aspect of the subject matter described in this specification can be implemented in computer program products that include a computer program product tangibly embodied in a computer-readable storage device and comprising instructions. The instructions, when executed by one or more processors, cause the processor to: identify content for inclusion in a display advertisement, the display advertisement to be presented in a block that has dimensions that may vary depending on a given received request; receive a plurality of style definitions to be associated with the display advertisement, each style definition being different and including a layout for the content to be used as criteria for when to apply a given style definition when generating an instantiation of the display advertisement for presentation to a user; receive a request for content including size information for a block where the content is to be displayed; determine that the display advertisement satisfies the request and is to be provided responsive to the request; determine which style definition to apply based at least in part on the size information and criteria for each of the plurality of style definitions that are associated with the display advertisement; generate an instantiation of the display advertisement using the determined style definition; and provide the instantiation of the display advertisement responsive to the request.

These and other implementations can each optionally include one or more of the following features. Determining can include mapping a respective style definition to a range of values for a height and a width of the block that is supported by the respective style definition. The layout can define the location and size of the content to be included in a given instantiation of the display advertisement when using a respective style definition. The layout can include for at least one element of content a range of sizes that can be included in a given instantiation depending on the size information. The computer program product can further include instructions, that when executed, cause the one or more processors to determine a plurality of eligible content items that are responsive to the request, conduct an auction including the plurality of eligible content items, and where determining the display advertisement satisfies the request and is to be provided responsive to the request includes determining the display advertisement is a winner of the auction. The computer program product can further include instructions, that when executed, cause the one or more processors to provide a user interface for receiving style definition information from a display advertisement sponsor including layout information and criteria information for when to apply a respective style definition.

In general, another innovative aspect of the subject matter described in this specification can be implemented in systems, including a system comprising one or more processors and one or more memory elements including instructions. The instructions, when executed, cause the one or more processors to: identify content for inclusion in a display advertisement, the display advertisement to be presented in a block that has dimensions that may vary depending on a given received request; receive a plurality of style definitions to be associated with the display advertisement, each style definition being different and including a layout for the content to be used as criteria for when to apply a given style definition when generating an instantiation of the display advertisement for presentation to a user; receive a request for content including size information for a block where the content is to be displayed; determine that the display advertisement satisfies the request and is to be provided responsive to the request; determine which style definition to apply based at least in part on the size information and criteria for each of the plurality of style definitions that are associated with the display advertisement; generate an instantiation of the display advertisement using the determined style definition; and provide the instantiation of the display advertisement responsive to the request.

These and other implementations can each optionally include one or more of the following features. Determining can include mapping a respective style definition to a range of values for a height and a width of the block that is supported by the respective style definition. The layout can define the location and size of the content to be included in a given instantiation of the display advertisement when using a respective style definition. The system can further include instructions, that when executed, cause the one or more processors to determine a plurality of eligible content items that are responsive to the request, conduct an auction including the plurality of eligible content items, and where determining the display advertisement satisfies the request and is to be provided responsive to the request includes determining the display advertisement is a winner of the auction. The system can further including instructions, that when executed, cause the one or more processors to provide a user interface for receiving style definition information from a display advertisement sponsor including layout information and criteria information for when to apply a respective style definition.

Particular implementations may realize none, one or more of the following advantages. Content providers, such as advertisers, need not define multiple versions and layouts of the same advertisement creative, each associated with a different slot size.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment for delivering content.

FIG. 2 shows an example system for providing content using style definitions.

FIGS. 3A-3D show example content blocks for receiving an instantiation of a creative using different style definitions.

FIG. 4 is a block diagram of an example process for providing content item using a selected style definition.

FIG. 5 is a flowchart of an example process for providing content using block-size-compatible style definitions.

FIG. 6 is a block diagram of an example computer system that can be used to implement the methods, systems and processes described in this disclosure.

Like reference numbers and designations in the various drawings indicate like elements.

### DETAILED DESCRIPTION

This document describes methods, processes and systems for providing content, such as of the form of display advertisements, using style definitions. For example, a different style definition can be selected at run-time depending on the dimensions of the advertisement block and which specific one of different style definitions has range dimensions that match that size. As a result, a single creative can be defined, and the size of the content item that is provided based on the creative can be determined dynamically at run-time (e.g., when an advertisement block is to be filled on a web page).

For example, each advertisement creative in an advertisement campaign can have, associated with it, multiple style definitions. Each style definition can be used to style an advertisement creative's hypertext markup language (HTML) tags, which can define the advertisement creative's content and elements, including the position and size of the elements. Each style definition can be defined, for example, to style content for a range of sizes. However, the style definition itself does not identify any specific block size specifications. Rather, at run-time (e.g., advertisement selection time), an algorithm can determine which style definition is to be applied in order to fill the advertisement block associated with the request.

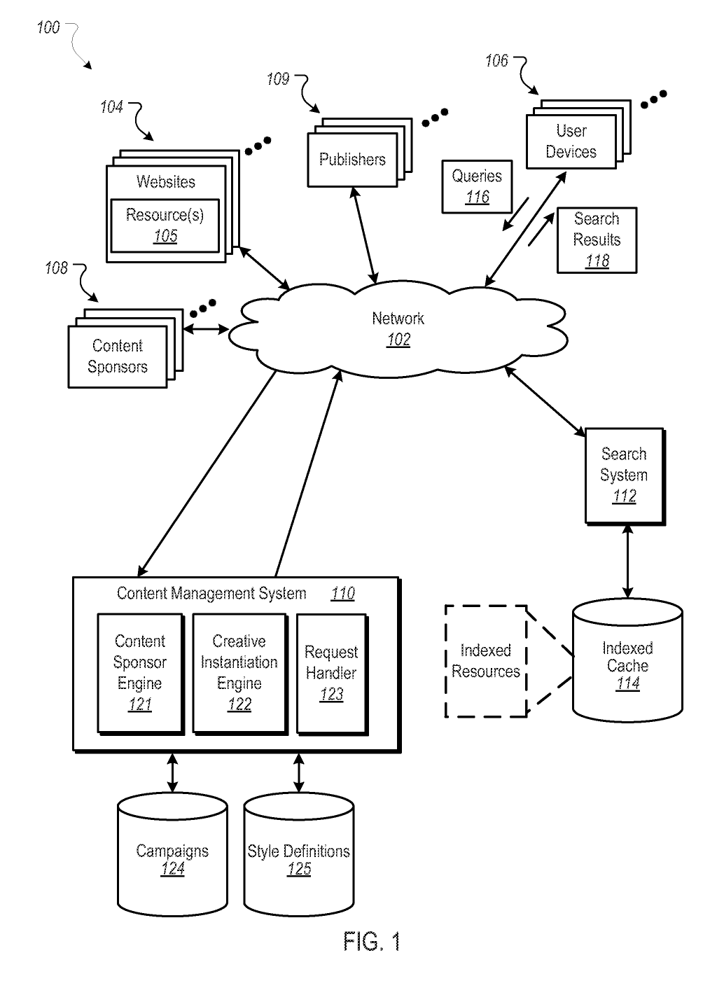

FIG. 1 is a block diagram of an example environment 100 for delivering content. The example environment 100 includes a content management system 110 for selecting and providing content in response to requests for content. The example environment 100 includes a network 102, such as a local area network (LAN), a wide area network (WAN), the Internet, or a combination thereof. The network 102 connects websites 104, user devices 106, content sponsors 108 (e.g., advertisers), publishers 109, and the content management system 110. The example environment 100 may include many thousands of websites 104, user devices 106, content sponsors 108 and publishers 109.

A website 104 includes one or more resources 105 associated with a domain name and hosted by one or more servers. An example website is a collection of webpages formatted in HTML that can contain text, images, multimedia content, and programming elements, such as scripts. Each website 104 can be maintained by a content publisher, which is an entity that controls, manages and/or owns the website 104.

A resource 105 can be any data that can be provided over the network 102. A resource 105 can be identified by a resource address that is associated with the resource 105. Resources include HTML pages, word processing documents, portable document format (PDF) documents, images, video, and news feed sources, to name only a few. The resources can include content, such as words, phrases, images, video and sounds, that may include embedded information (such as meta-information hyperlinks) and/or embedded instructions (such as JavaScript™ scripts).

A user device 106 is an electronic device that is under control of a user and is capable of requesting and receiving resources over the network 102. Example user devices 106 include personal computers (PCs), televisions with one or more processors embedded therein or coupled thereto, set-top boxes, mobile communication devices (e.g., smartphones), tablet computers and other devices that can send and receive data over the network 102. A user device 106 typically includes one or more user applications, such as a web browser, to facilitate the sending and receiving of data over the network 102.

A user device 106 can request resources 105 from a website 104. In turn, data representing the resource 105 can be provided to the user device 106 for presentation by the user device 106. The data representing the resource 105 can also include data specifying a portion of the resource or a portion of a user display, such as a presentation location of a pop-up window or a block of a third-party content site or webpage, in which content can be presented. These specified portions of the resource or user display are referred to herein as slots (e.g., ad slots).

To facilitate searching of these resources, the environment 100 can include a search system 112 that identifies the resources by crawling and indexing the resources provided by the content publishers on the websites 104. Data about the resources can be indexed based on the resource to which the data corresponds. The indexed and, optionally, cached copies of the resources can be stored in an indexed cache 114.

User devices 106 can submit search queries 116 to the search system 112 over the network 102. In response, the search system 112 accesses the indexed cache 114 to identify resources that are relevant to the search query 116. The search system 112 identifies the resources in the form of search results 118 and returns the search results 118 to the user devices 106 in search results pages. A search result 118 can be data generated by the search system 112 that identifies a resource that is provided in response to a particular search query, and includes a link to the resource. In some implementations, the search results 118 include the content itself, such as a map, or an answer, such as in response to a query for a store's products, phone number, address or hours of operation. In some implementations, the content management system 110 can generate search results 118 using information (e.g., identified resources) received from the search system 112. An example search result 118 can include a webpage title, a snippet of text or a portion of an image extracted from the webpage, and the URL of the webpage. Search results pages can also include one or more slots in which other content items (e.g., ads) can be presented.

In some implementations, slots on search results pages or other webpages can include content blocks for content items that have been provided as part of a reservation process. In a reservation process, a publisher and a content item sponsor enter into an agreement where the publisher agrees to publish a given content item (or campaign) in accordance with a schedule (e.g., provide 1000 impressions by date X) or other publication criteria. In some implementations, content items that are selected to fill the requests for content blocks can be selected based, at least in part, on priorities associated with a reservation process (e.g., based on urgency to fulfill a reservation).

When a resource 105, search results 118 and/or other content are requested by a user device 106, the content management system 110 receives a request for content. The request for content can include characteristics of the blocks that are defined for the requested resource or search results page, and can be provided to the content management system 110.

For example, a reference (e.g., URL) to the resource for which a block is defined, a size of the block, and/or media types that are available for presentation in the block can be provided to the content management system 110. Similarly, keywords associated with a requested resource (“resource keywords”) or a search query 116 for which search results are requested can also be provided to the content management system 110 to facilitate identification of content that is relevant to the resource or search query 116.

Based at least in part on data included in the request, the content management system 110 can select content that is eligible to be provided in response to the request (“eligible content items”). For example, eligible content items can include eligible ads having characteristics matching the characteristics of ad blocks and that are identified as relevant to specified resource keywords or search queries 116. In some implementations, the selection of the eligible content items can further depend on user signals, such as demographic signals and behavioral signals.

The content management system 110 can select from the eligible content items that are to be provided for presentation in blocks of a resource or search results page based at least in part on results of an auction (or by some other selection process). For example, for the eligible content items, the content management system 110 can receive offers from content sponsors 108 and allocate the blocks, based at least in part on the received offers (e.g., based on the highest bidders at the conclusion of the auction or based on other criteria, such as those related to satisfying open reservations). The offers represent the amounts that the content sponsors are willing to pay for presentation (or selection or other interaction with) of their content with a resource or search results page. For example, an offer can specify an amount that a content sponsor is willing to pay for each 1000 impressions (i.e., presentations) of the content item, referred to as a CPM bid. Alternatively, the offer can specify an amount that the content sponsor is willing to pay (e.g., a cost per engagement) for a selection (i.e., a click-through) of the content item or a conversion following selection of the content item. For example, the selected content item can be determined based on the offers alone, or based on the offers of each content sponsor being multiplied by one or more factors, such as quality scores derived from content performance, landing page scores, and/or other factors.

The content management system 110 can include plural engines. For example, a content sponsor engine 121 can allow a content sponsor to create and maintain creatives, e.g., stored as campaigns 124. In some implementations, the content sponsor engine 121 can also allow a content sponsor to optionally define multiple different style definitions 125 for any or all of the creatives. Each style definition 125, for example, can identify layouts of content elements and height and width dimension ranges associated with each style.

A creative instantiation engine 122 can use the style definitions 125 in order to generate instances of the creative using different style definitions. For example, in response to a request for content to fill an advertisement block on a web page or for some other reason (e.g., within a game or application), the creative instantiation engine 122 can identify a specific one of the style definitions 125 that maps to the size of the corresponding advertisement block. Then, the creative instantiation engine 122 can use the specific style definition 125 to generate an instance of the creative that is dynamically sized to fit the advertisement block.

In some implementations, requests for content can be handled by a request handler 123, e.g., which can determine and confirm a content item's eligibility before the creative instantiation engine 122 generates an instance of a specific size. By making creatives available for different sizes of blocks, a content sponsor can have its content provided in more situations, which can lead to more conversions.

A conversion can be said to occur when a user performs a particular transaction or action related to a content item provided with a resource or search results page. What constitutes a conversion may vary from case-to-case and can be determined in a variety of ways. For example, a conversion may occur when a user clicks on a content item (e.g., an ad), is referred to a webpage, and consummates a purchase there before leaving that webpage. A conversion can also be defined by a content provider to be any measurable or observable user action, such as downloading a white paper, navigating to at least a given depth of a website, viewing at least a certain number of webpages, spending at least a predetermined amount of time on a web site or webpage, registering on a website, or experiencing media. Other actions that constitute a conversion can also be used

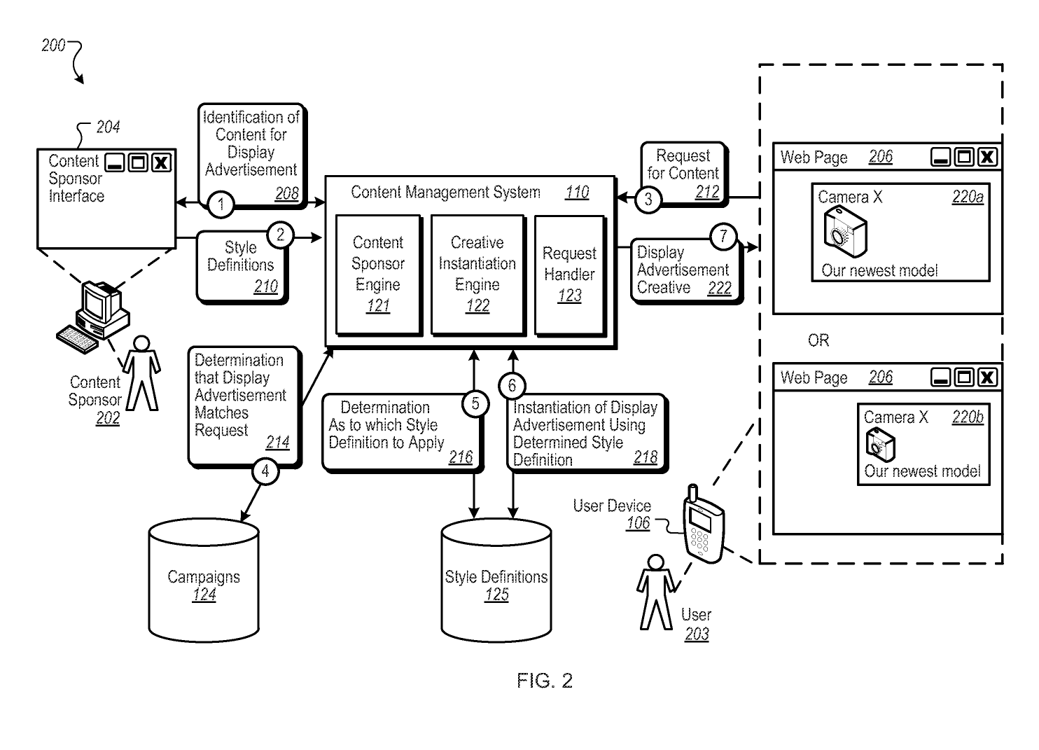

FIG. 2 shows an example system 200 for providing content using style definitions. For example, in response to a request for content 212 from a web page 206, the content management system 110 can provide an instance of a display advertisement creative 222 using a style definition 125 that matches the size of an advertisement block on the web page 206. The style definitions 125 can be defined, for example, by a content sponsor 202, e.g., using a content sponsor interface 204. Different style definitions 125 can be designated for different layouts of a display advertisement, and each layout can include a range of block sizes associated with requests for content that may be received. In some implementations, the sizes that are specified are in the form of ranges, and are not tied to specific block sizes. Rather a style definition is chosen at advertisement-request-time that matches the block size. An example sequence of steps follows that provides one possible series of events for providing content (e.g., advertisements) in this way.

At step 1, the content sponsor engine 121 can identify content 208 for a particular display advertisement, e.g., for presentation to the content sponsor 202 in the content sponsor interface 204. For example, the presentation of content can identify elements in the advertisement, such as one or more of text, image, video, HTML (e.g., HTML5), canvas, flash and/or other content elements that may be included in instantiations of a display advertisement creative. The content sponsor interface 204 can allow the content sponsor 202 to designate the size and location of the content elements for different dimension ranges. The ranges can correspond to (but don't specifically identify) block sizes associated with requests for content that may be received. For example, the content sponsor 202 can use the content sponsor interface 204 to specify how a display advertisement is to be presented in different dimensions, e.g., that may vary depending on a block size for a given received request for content 212.

At step 2, the content sponsor 202 can provide style definitions 210, including definitions for the position and size ranges associated with individual content elements in the display advertisement. Each style definition can be different and can include a layout for the content to be used as criteria for when to apply a given style definition when generating an instantiation of the display advertisement for presentation to a user. In some implementations, the layouts can include and/or use cascading style sheets (CSS) that are ultimately used to style HTML tags used to render the content.

As an example, the style definitions 210 can include different styles for the same camera-related display advertisement. For example, one of the style definitions (e.g., Style 1) can have a height dimension range of 200-250 pixels and a width dimension range of 300-400 pixels. A different one of the style definitions (e.g., Style 2) can have a height dimension range of 150-199 pixels and a width dimension range of 200-299 pixels. While the style definitions 210 in this example are received from the content sponsor interface 204, the style definitions 210 can also be received from other sources, including sources that generate the style definitions automatically or semi-automatically. Regardless of the source, the received inputs can be stored as style definitions 125.

When the style definitions 210 are created, they can be independent of any knowledge of specific requests for content or specific block sizes. For example, when a request for content is subsequently received (e.g., at step 3), an algorithm can look at the block size associated with the request and select a style definition (if any) that best matches the request.

At step 3, the content management system 110 can receive a request for content 212 from the user device 106, e.g., to fill an advertisement block of a particular size (e.g., X by Y pixels) on the web page 206. The request for content 212 can include the size information as well as selection criteria for selecting the type of content for filling the advertisement block (e.g., including keywords such as “camera”). In some implementations, the request handler 123 can handle the request for content 212.

At step 4, the content management system 110 can determine a content item 214 (e.g., an advertisement) that satisfies the request for content 212 and that can be provided responsive to the request (e.g., is an eligible content item, as described above). For example, the content management system 110 can select the camera-related advertisement among other advertisements that match the selection criteria in the request and that meet size constraints specified in size information that accompanies the request. For example, the request for content 212 may identify the size of the advertisement block as being X by Y pixels, and the camera-related advertisement selected for the block must have defined for it style definitions that include that size. In some implementations, a creative can have stored with it overall dimension ranges that include a union of all of the dimension ranges of the individual style definitions. In this way, an advertisement can be selected as an eligible advertisement without examining individual dimension ranges of the specific style definitions.

At step 5, the creative instantiation engine 122 can determine 216 which style definition to apply based at least in part on the size information and criteria for each of the plurality of style definitions that are associated with the display advertisement. For example, if the X by Y advertisement block size falls within the dimension ranges of Style 1 (e.g., a height of 200-250 pixels by a width of 300-400 pixels), then Style 1 can be determined. In another example, if the X by Y advertisement block size falls within the dimension ranges of Style 2 (e.g., a height of 150-199 pixels by a width of 200-299 pixels), then Style 2 can be determined.

In some implementations, a block size-to-style definition matching algorithm can be used. For example, the matching algorithm can access size range information in a table or other data structure that indicates: for heights 200-250 and widths 300-400, use style definition #1; for heights 150-199 and widths 200-299, use style definition #2; and for heights 100-149 and widths 600-900, use style definition #3. Other style definitions can exist. In some implementations, relationships between style definitions and dimension ranges can be 1-1, e.g., so that each dimension (e.g., corresponding to an advertisement block) maps to a unique style definition.

Each style definition can have a layout specification that specifies where each element of the advertisement is to be displayed, what the height and width of each element is, what padding and margin values each element has, element colors, motion, shadows, background color, background image, text colors, and other features. As described above, the style definitions do not specify advertisement block size directly.

At step 6, the creative instantiation engine 122 can generate an instantiation 218 of the display advertisement using the determined style definition. For example, if the dimensions of the advertisement block on the web page 206 match Style 1, then the creative instantiation engine 122 can generate an advertisement 220a that is an instantiated version of the camera-related creative using Style 1. Otherwise, if the dimensions of the advertisement block matches Style 2, then the creative instantiation engine 122 can generate an advertisement 220b that uses Style 2. Other style definitions can be used for other block sizes.

At step 7, the content management system can provide the instantiated advertisement creative that is responsive to the request. For example, the request handler 122 can provide the display advertisement creative 222 to the user device 106 for use in the web page 206. The display advertisement creative 222 that is provided will be the advertisement 220a, 220b or some other advertisement.

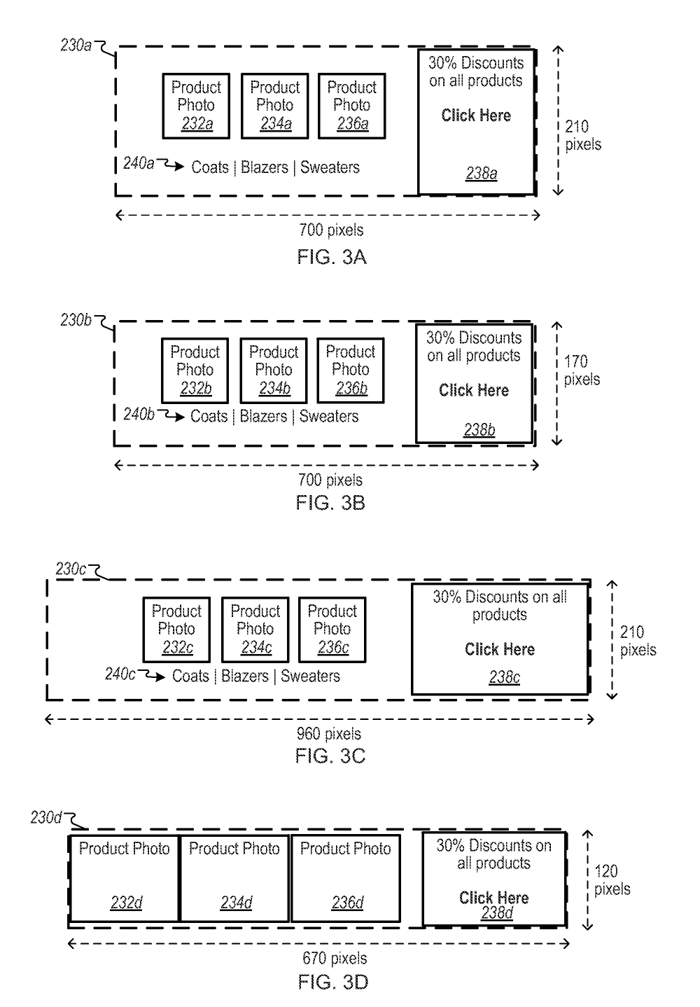

FIGS. 3A-3D show example advertisement blocks 230a-230d for receiving an instantiation of an advertisement creative using different style definitions. For example, the advertisement blocks 230a-230d can each use a style definition that automatically changes the layout of content based on the size of the advertisement block. For example, Style A may be defined to have a width dimension range of 700-960 pixels and a height range of 170-210 pixels. Style B, for example, may be defined to have a width dimension range of 480-680 pixels and a height range of 100-160 pixels. As a result, the creative instantiation engine 122 can select Style A for advertisement blocks 230a-230c, and select Style B for advertisement block 230d.

Referring to FIG. 3A, for example, elements 232a-240a are positioned in the advertisement block 230a that has a size of 700 pixels wide by 210 pixels high. Referring to FIG. 3B, advertisement block 230b is shorter than advertisement block 230a. The height (e.g., 170 pixels) is still within the range of Style A, for example, and padding automatically occurs. As a result, element 238b is shorter than element 238a. Also, white space below elements 232b-236b and above element 240b is reduced (e.g., proportionally).

Referring to FIG. 3C, advertisement block 230c also uses Style A, but additional white space is added on the left and right sides of elements 232c-236c. Further, element 238c is stretched horizontally.

Referring to FIG. 3D, advertisement block 230d uses Style B, for example, which includes elements 232d-236d that have a different layout than similar elements of Style A. Substantially no white space exists in this example except to the left of element 238d. Further, as defined for Style B, no caption element similar to elements 240a-240c (e.g., “Coats|Blazers|Sweaters”) exists below elements 232d-236d.

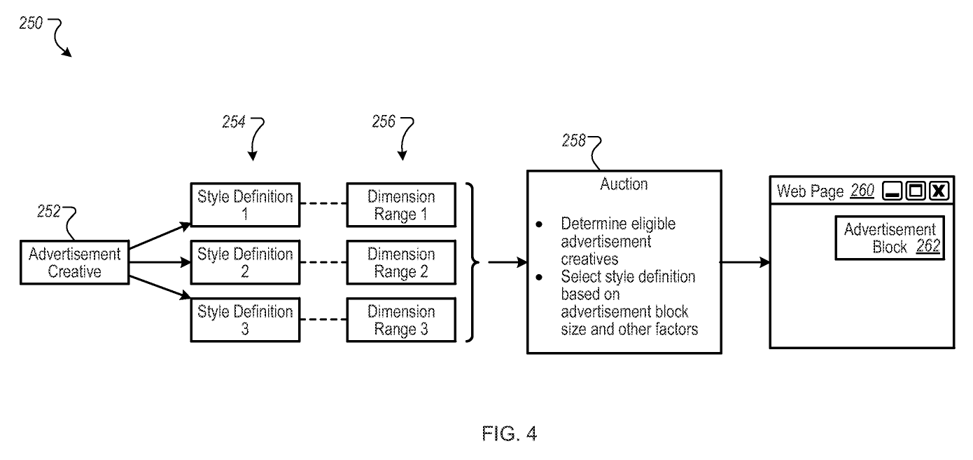

FIG. 4 is a block diagram of an example process 250 for providing content (such as an advertisement) using a selected style definition. For example, the process 250 can start with the creation of an advertisement creative 252 for which different style definitions 254 are specified by a content sponsor. Each of the different style definitions 254 can have an associated dimension range 256, such as including a range of heights and a range of widths for each style definition. The advertisement creative 252 can be one of thousands or more of advertisement creatives that are defined and stored, some of which may or may not include style definitions.

The stored advertisement creatives and their style definitions can be used to provide advertisements to fill advertisement blocks. For example, in response to a request for content to fill an advertisement block 262 on a web page 260, the advertisement creative 252 and other advertisement creatives can be part of an auction 258 or some other selection process (e.g., reservation system). The auction 258, for example, can determine eligible advertisement creatives that meet the selection criteria of the request, e.g., by matching keywords or other advertisement selection criteria. If the advertisement creative 252 is determined to be eligible, then one of the different style definitions 254 can be selected, e.g., based on the size of the advertisement block 262 and other factors. As a result, the advertisement that the user sees may appear as one of the formats shown in FIGS. 3A-3D or some other style.

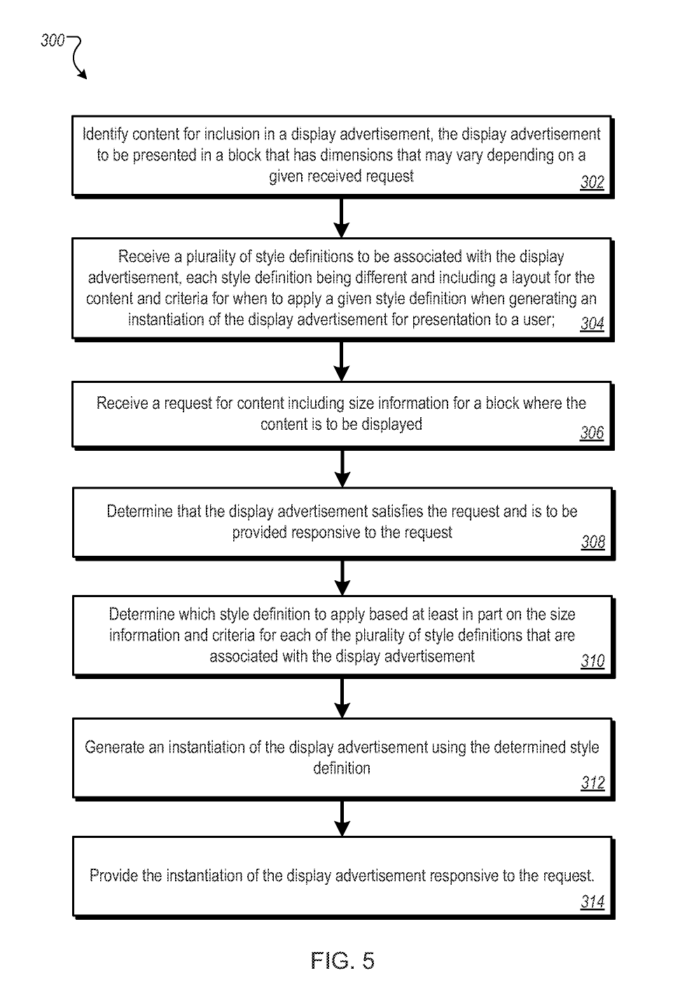

FIG. 5 is a flowchart of an example process 300 for providing content (such as advertisements) using block-size-compatible style definitions. In some implementations, the content management system 110 can perform steps of the process 300 using instructions that are executed by one or more processors. FIGS. 1-2 are used to provide example structures for performing the steps of the process 300.

Content is identified for inclusion in a display advertisement that is to be presented in a block having dimensions that may vary depending on a given received request (302). For example, the content management system 110 can identify a display advertisement (e.g., a camera-related advertisement) that is part of a campaign 124. The content sponsor engine 121 can provide the information to the content sponsor interface 204, e.g., executing on a computer device used by the content sponsor 202.

In some implementations, the content for inclusion in the display advertisement includes one or more of text, image, video, HTML, canvas and flash data. For example, information about the display advertisement that is displayed to the content sponsor interface 204 can include an image of the camera, a description of the camera, and other content elements.

A plurality of style definitions is received that are to be associated with the display advertisement (304). Each style definition is different and includes a layout for the content to be used as criteria for when to apply a given style definition when generating an instantiation of the display advertisement for presentation to a user. For example, using the content sponsor interface 204, the content sponsor 202 can specify several different style definitions, e.g., style definitions A and B as described above with reference to FIG. 2.

In some implementations, the layout can define the location and size of the content to be included in a given instantiation of the display advertisement when using a respective style definition. For example, a style definition can specify that a logo is to be presented with a particular area, such as using left, right, top, bottom, middle/center indicators and or percentages (e.g., “place the logo in top 20% of the advertisement, justified to the left side”).

In some implementations, the layout can include, for at least one element of content, a range of sizes that can be included in a given instantiation depending on the size information. For example, the style definition may indicate that one or more images are to be presented using a particular minimum size, but can optionally be sized (e.g., N>100%) of that size, a percentage of a block's dimension, or some other size specification. In some implementations, layout sizes can use, for example, N-height and N-width, where N-height is a percentage of an ad slot's height, N-width is a percentage of an ad slot's width, and where both N-height and N-width do not exceed 100% of an ad slot's height and width, respectively. These settings, for example, can allow the height and width of the element to take up x % of the advertisement block size, whatever it may be. This can allow the element to be resized based on the dimensions of the containing advertisement block. However, the style definition does not contain absolute dimension ranges. Dimension ranges may exist, for example, in tables that map ranges with style definitions that are used to select which style definition to use.

A request for content is received that includes size information for a block where the content is to be displayed (306). For example, the request handler 123 can receive the request for content 212 to fill an advertisement block on the web page 206.

In some implementations, the size information can be based on a block size selected by a publisher of a page in which the display advertisement is to be presented, and the block size can be arbitrary or customizable by the publisher and not necessarily a standard size specified by an advertisement serving system. For example, publishers may specify any feasible size for a content item slot within their published content, and the size need not correspond to size dimensions typically used for advertisement blocks.

A determination is made that the display advertisement satisfies the request and is to be provided responsive to the request (308). For example, the request handler 123 can identify an advertisement creative from the campaigns 124 that meets the selection criteria of the request for content 212.

A determination is made as to which style definition to apply based at least in part on the size information and criteria for each of the plurality of style definitions that are associated with the display advertisement (310). For example, the creative instantiation engine 122 can determine a specific one of the style definitions 125 that is to be used based at least in part on the size information and/or other criteria associated with the request for content 212, including the size of the advertisement block.

In some implementations, determining which style definition to apply can include mapping a respective style definition to a range of values for a height and a width of the block that is supported by the respective style definition. For example, the creative instantiation engine 122 can determine that definition A has a range of values for height and width that matches the block size associated with the request for content.

An instantiation of the display advertisement is generated using the determined style definition (312). For example, the creative instantiation engine 122 can generate an instantiation of the display advertisement using Style 1, Style 2, or some other style definition.

The instantiation of the display advertisement is provided responsive to the request (314). As an example, the request handler 123 can provide either the advertisement 220a, 220b or some other advertisement that is responsive to the request.

In some implementations, the process 300 can further include determining a plurality of eligible content items that are responsive to the request and conducting an auction including the plurality of eligible content items. Further, determining the display advertisement satisfies the request and is to be provided responsive to the request can include determining the display advertisement is a winner of the auction. For example, advertisements that are selected as described above can enter auctions with other content items that match the selection criteria associated with the request. In some implementations, different bid amounts can exist for each of the different style definitions, or generally, a different (e.g., higher) bid for an advertisement that includes different style definitions.

In some implementations, the process 300 can further include providing a user interface for receiving style definition information from a display advertisement sponsor including layout information and criteria information for when to apply a respective style definition. As an example, content sponsors can use the content sponsor interface 204 or some other interface(s) to provide information associated with style definitions 125.

In some implementations, the style definition can be of the form of a cascading style sheet. For example, each of the style definitions 125 can include CSS style sheet information that is used to tag HTML with style information when the advertisement is provided in response to a request.

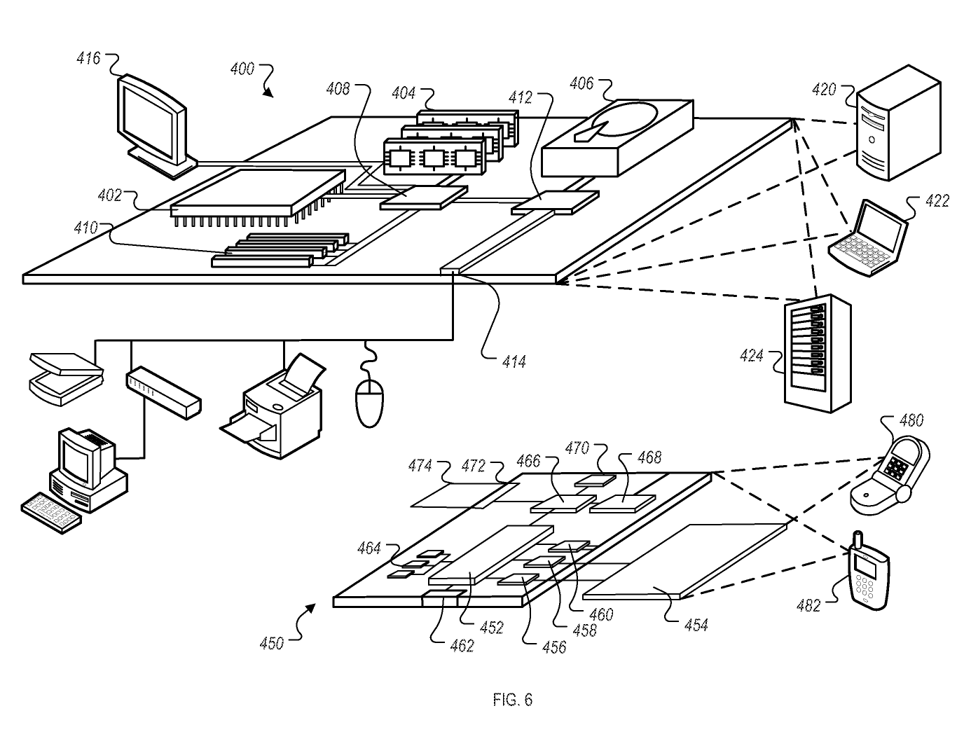

FIG. 6 is a block diagram of example computing devices 400, 450 that may be used to implement the systems and methods described in this document, as either a client or as a server or plurality of servers. Computing device 400 is intended to represent various forms of digital computers, such as laptops, desktops, workstations, personal digital assistants, servers, blade servers, mainframes, and other appropriate computers. Computing device 400 is further intended to represent any other typically non-mobile devices, such as televisions or other electronic devices with one or more processers embedded therein or attached thereto. Computing device 450 is intended to represent various forms of mobile devices, such as personal digital assistants, cellular telephones, smartphones, and other computing devices. The components shown here, their connections and relationships, and their functions, are meant to be exemplary only, and are not meant to limit implementations of the inventions described and/or claimed in this document.

Computing device 400 includes a processor 402, memory 404, a storage device 406, a high-speed interface 408 connecting to memory 404 and high-speed expansion ports 410, and a low speed interface 412 connecting to low speed bus 414 and storage device 406. Each of the components 402, 404, 406, 408, 410, and 412, are interconnected using various busses, and may be mounted on a common motherboard or in other manners as appropriate. The processor 402 can process instructions for execution within the computing device 400, including instructions stored in the memory 404 or on the storage device 406 to display graphical information for a GUI on an external input/output device, such as display 416 coupled to high speed interface 408. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 404 stores information within the computing device 400. In one implementation, the memory 404 is a computer-readable medium. In one implementation, the memory 404 is a volatile memory unit or units. In another implementation, the memory 404 is a non-volatile memory unit or units.

The storage device 406 is capable of providing mass storage for the computing device 400. In one implementation, the storage device 406 is a computer-readable medium. In various different implementations, the storage device 406 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 404, the storage device 406, or memory on processor 402.

The high speed controller 408 manages bandwidth-intensive operations for the computing device 400, while the low speed controller 412 manages lower bandwidth-intensive operations. Such allocation of duties is exemplary only. In one implementation, the high-speed controller 408 is coupled to memory 404, display 416 (e.g., through a graphics processor or accelerator), and to high-speed expansion ports 410, which may accept various expansion cards (not shown). In the implementation, low-speed controller 412 is coupled to storage device 406 and low-speed expansion port 414. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 420, or multiple times in a group of such servers. It may also be implemented as part of a rack server system 424. In addition, it may be implemented in a personal computer such as a laptop computer 422. Alternatively, components from computing device 400 may be combined with other components in a mobile device (not shown), such as device 450. Each of such devices may contain one or more of computing device 400, 450, and an entire system may be made up of multiple computing devices 400, 450 communicating with each other.

Computing device 450 includes a processor 452, memory 464, an input/output device such as a display 454, a communication interface 466, and a transceiver 468, among other components. The device 450 may also be provided with a storage device, such as a microdrive or other device, to provide additional storage. Each of the components 450, 452, 464, 454, 466, and 468, are interconnected using various buses, and several of the components may be mounted on a common motherboard or in other manners as appropriate.

The processor 452 can process instructions for execution within the computing device 450, including instructions stored in the memory 464. The processor may also include separate analog and digital processors. The processor may provide, for example, for coordination of the other components of the device 450, such as control of user interfaces, applications run by device 450, and wireless communication by device 450.

Processor 452 may communicate with a user through control interface 458 and display interface 456 coupled to a display 454. The display 454 may be, for example, a TFT LCD display or an OLED display, or other appropriate display technology. The display interface 456 may comprise appropriate circuitry for driving the display 454 to present graphical and other information to a user. The control interface 458 may receive commands from a user and convert them for submission to the processor 452. In addition, an external interface 462 may be provided in communication with processor 452, so as to enable near area communication of device 450 with other devices. External interface 462 may provide, for example, for wired communication (e.g., via a docking procedure) or for wireless communication (e.g., via Bluetooth or other such technologies).

The memory 464 stores information within the computing device 450. In one implementation, the memory 464 is a computer-readable medium. In one implementation, the memory 464 is a volatile memory unit or units. In another implementation, the memory 464 is a non-volatile memory unit or units. Expansion memory 474 may also be provided and connected to device 450 through expansion interface 472, which may include, for example, a subscriber identification module (SIM) card interface. Such expansion memory 474 may provide extra storage space for device 450, or may also store applications or other information for device 450. Specifically, expansion memory 474 may include instructions to carry out or supplement the processes described above, and may include secure information also. Thus, for example, expansion memory 474 may be provide as a security module for device 450, and may be programmed with instructions that permit secure use of device 450. In addition, secure applications may be provided via the SIM cards, along with additional information, such as placing identifying information on the SIM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 464, expansion memory 474, or memory on processor 452.

Device 450 may communicate wirelessly through communication interface 466, which may include digital signal processing circuitry where necessary. Communication interface 466 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 468. In addition, short-range communication may occur, such as using a Bluetooth, WiFi, or other such transceiver (not shown). In addition, GPS receiver module 470 may provide additional wireless data to device 450, which may be used as appropriate by applications running on device 450.

Device 450 may also communicate audibly using audio codec 460, which may receive spoken information from a user and convert it to usable digital information. Audio codec 460 may likewise generate audible sound for a user, such as through a speaker, e.g., in a handset of device 450. Such sound may include sound from voice telephone calls, may include recorded sound (e.g., voice messages, music files, etc.) and may also include sound generated by applications operating on device 450.

The computing device 450 may be implemented in a number of different forms, as shown in the figure. For example, it may be implemented as a cellular telephone 480. It may also be implemented as part of a smartphone 482, personal digital assistant, or other mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. Other programming paradigms can be used, e.g., functional programming, logical programming, or other programming. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
identifying a particular display advertisement that includes a particular set of content;
receiving, by one or more processors, a plurality of style definitions that specify various different visual formats for the particular set of content, including a first style definition that specifies a first arrangement of the particular set of content that differs from a second style definition that specifies a second arrangement of the particular set of content;
storing, in digital memory, the plurality of style definitions in association with the particular display advertisement, including mapping the first style definition to a first range of block heights and a first range of block widths and mapping the second style definition to a different range of block heights and a different range of block widths;
after storing the plurality of style definitions, receiving, from a user device, a request for content including size information for a block of a publisher page where the particular display advertisement is to be displayed, wherein the size information for the block varies on a per-request basis and specifies a given block height and a given block width;
identifying the particular display advertisement for presentation in the block of the publisher page;
selecting, from the digital memory, one of the first style definition or the second style definition to be applied to the particular display advertisement based on the given block height and the given block width specified in the request, including selecting the first style definition when the given block height and the given block width are respectively included in the first range of block heights and the first range of block widths and selecting the second style definition when the given block height and the given block width are respectively included in the second range of block heights and the second range of block widths;
dynamically generating, automatically at runtime and by one or more processors, an instantiation of the particular display advertisement including applying the selected style definition to the particular set of content of the particular display advertisement, wherein applying the selected style definition to the particular set of content includes resizing at least one portion of the particular set of content within the particular display advertisement and arranging items in the particular set of content within the instantiation based on a cascading style sheet corresponding to the selected style definition; and
updating a user interface of the user device to include the instantiation of the particular display advertisement responsive to the request.

2. The method of claim 1 wherein the particular set of content includes one or more of text, image, video, hypertext markup language, canvas and flash data, and wherein applying the selected style definition comprises modifying html tags of the particular display advertisements.

3. (canceled)

4. The method of claim 1 wherein the plurality of style definitions define a location and a size of the particular set of content to be included in a given instantiation of the particular display advertisement when using a respective style definition.

5. The method of claim 4 wherein the plurality of style definitions include for at least one element of content a range of sizes that can be included in a given instantiation depending on the size information.

6. The method of claim 1 further comprising determining a plurality of eligible content items that are responsive to the request and conducting an auction including the plurality of eligible content items, and wherein identifying the particular display advertisement for presentation in the block of the publisher page includes determining the particular display advertisement is a winner of the auction.

7. The method of claim 1 further comprising providing a user interface for receiving style definition information including layout information and criteria information for when to apply a respective style definition.

8. (canceled)

9. The method of claim 1 wherein the size information is based on a block size selected by a publisher of the publisher page in which the particular display advertisement is to be presented and wherein the block size is arbitrary or customizable by the publisher and not necessarily a standard size specified by an advertisement serving system.

10. A computer program product embodied in a tangible medium including instructions, that when executed, cause one or more processors to:
identify a particular display advertisement that includes a particular set of content;
receive a plurality of style definitions that specify various different visual formats for the particular set of content, including a first style definition that specifies a first arrangement of the particular set of content that differs from a second style definition that specifies a second arrangement of the particular set of content;
store, in digital memory, the plurality of style definitions in association with the particular display advertisement, including mapping the first style definition to a first range of block heights and a first range of block widths and mapping the second style definition to a different range of block heights and a different range of block widths;
after storing the plurality of style definitions, receive, from a user device, a request for content including size information for a block of a publisher page where the particular display advertisement is to be displayed, wherein the size information for the block varies on a per-request basis and specifies a given block height and a given block width;
identify the particular display advertisement for presentation in the block of the publisher page;
select, from the digital memory, one of the first style definition or the second style definition to be applied to the particular display advertisement based on the given block height and the given block width specified in the request, including selecting the first style definition when the given block height and the given block width are respectively included in the first range of block heights and the first range of block widths and selecting the second style definition when the given block height and the given block width are respectively included in the second range of block heights and the second range of block widths;
dynamically generate, automatically at runtime and using one or more processors, an instantiation of the particular display advertisement including applying the selected style definition to the particular set of content of the particular display advertisement, wherein applying the selected style definition to the particular set of content includes resizing at least one portion of the particular set of content within the particular display advertisement and arranging items in the particular set of content within the instantiation based on a cascading style sheet corresponding to the selected style definition; and
update a user interface of the user device to include the instantiation of the particular display advertisement responsive to the request.

11. (canceled)

12. The computer program product of claim 10 wherein the plurality of style definitions define a location and a size of the particular set of content to be included in a given instantiation of the particular display advertisement when using a respective style definition.

13. The computer program product of claim 10 wherein the plurality of style definitions include for at least one element of content a range of sizes that can be included in a given instantiation depending on the size information.

14. The computer program product of claim 10 further including instructions, that when executed, cause the one or more processors to determine a plurality of eligible content items that are responsive to the request and conduct an auction including the plurality of eligible content items, and wherein identifying the particular display advertisement for presentation in the block of the publisher page includes determining the particular display advertisement is a winner of the auction.

15. The computer program product of claim 10 further including instructions, that when executed, cause the one or more processors to provide a user interface for receiving style definition information including layout information and criteria information for when to apply a respective style definition.

16. A system comprising:
one or more processors; and
one or more memory elements including instructions that when executed cause the one or more processors to:
identify a particular display advertisement that includes a particular set of content;
receive a plurality of style definitions that specify various different visual formats for the particular set of content, including a first style definition that specifies a first arrangement of the particular set of content that differs from a second style definition that specifies a second arrangement of the particular set of content;
store, in digital memory, the plurality of style definitions in association with the particular display advertisement, including mapping the first style definition to a first range of block heights and a first range of block widths and mapping the second style definition to a different range of block heights and a different range of block widths;
after storing the plurality of style definitions, receive, from a user device, a request for content including size information for a block of a publisher page where the particular display advertisement is to be displayed, wherein the size information for the block varies on a per-request basis and specifies a given block height and a given block width;
identify the particular display advertisement for presentation in the block of the publisher page;
select, from the digital memory, one of the first style definition or the second style definition to be applied to the particular display advertisement based on the given block height and the given block width specified in the request, including selecting the first style definition when the given block height and the given block width are respectively included in the first range of block heights and the first range of block widths and selecting the second style definition when the given block height and the given block width are respectively included in the second range of block heights and the second range of block widths;
dynamically generate, automatically at runtime and using one or more processors, an instantiation of the particular display advertisement including applying the selected style definition to the particular set of content of the particular display advertisement, wherein applying the selected style definition to the particular set of content includes resizing at least one portion of the particular set of content within the particular display advertisement and arranging items in the particular set of content within the instantiation based on a cascading style sheet corresponding to the selected style definition; and
update a user interface of the user device to include the instantiation of the particular display advertisement responsive to the request.

17. (canceled)

18. The system of claim 16 wherein the plurality of style definitions define a location and a size of the particular set of content to be included in a given instantiation of the particular display advertisement when using a respective style definition.

19. The system of claim 16 further including instructions, that when executed, cause the one or more processors to determine a plurality of eligible content items that are responsive to the request and conduct an auction including the plurality of eligible content items, and wherein identifying the particular display advertisement for presentation in the block of the publisher page includes determining the particular display advertisement is a winner of the auction.

20. The system of claim 16 further including instructions, that when executed, cause the one or more processors to provide a user interface for receiving style definition information including layout information and criteria information for when to apply a respective style definition.
